(19) United States
(12) Patent Application Publication
(10) Pub. No.: US 2010/0188393 A1
(43) Pub. Date: Jul. 29, 2010

(54) PIXEL DRIVING APPARATUS AND PIXEL DRIVING METHOD

(75) Inventor: Shuichi Seki, Yonezawa-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignees: Pioneer Corporation, Tokyo (JP); Tohoku Pioneer Corporation, Tendo-shi (JP)

(21) Appl. No.: 12/376,689

(22) PCT Filed: Aug. 7, 2008
(86) PCT No.: PCT/JP2006/315580

§ 371 Date: Feb. 6, 2009

(51) Int. Cl. G06F 3/038

(52) U.S. Cl. 345/213

(57) ABSTRACT

In a pixel driving apparatus and a pixel driving method in which one frame period is time divided to a plurality of subframe periods, and gradation expression is performed by the sum of the turned-on periods of one or a plurality of subframe periods, occurrence of noise caused by the gradation expression is suppressed without increasing the number of subframes.

In a pixel driving apparatus having a plurality of pixels 30 disposed in the intersecting positions of a plurality of data lines B and a plurality of scan lines A and turned on by that pixel data signals are written thereto, wherein the plurality of pixels 30 are divided to at least two scan groups depending on a period from writing of the pixel data signals to erasing thereof, the pixel driving apparatus has a data line drive means 24 for supplying pixel data signals to the data lines B, a scan line drive means 25 for scanning scan lines so that the pixel data signals supplied to the data lines B are written to the pixels 30, and an erase scan means 26 for erasing the pixel data signals written to the pixels 30 in each of the scan groups.

### TECHNICAL FIELD

The present invention relates to a pixel driving apparatus and a pixel driving method for performing gradation expression based on a cumulated pixel turned-on time during one frame period.

### BACKGROUND ART

A display using a display panel constituting light-emitting devices disposed in matrix is under development. For example, an organic EL (electroluminescence) device using an organic material for a light emitting layer has been focus of attention as a light-emitting device used for such display panel.

There is an active matrix type display panel, in which active devices each consists of, for example, TFT (Thin Film Transistor) are added to respective EL devices disposed in matrix, as the display panel using such organic EL devices. Since the active matrix type display panel can realize low power consumption and has characteristics of less crosstalk between pixels, and the like, it is suitable particularly for a display with a high degree of fineness for constituting a large screen.

FIG. 1 shows an example of a circuit arrangement corresponding to one pixel 10 in a conventional active matrix type display panel. In FIG. 1, a gate G of a TFT 11 as a control transistor is connected to a scan line A1, and a source S thereof is connected to a data line B1. A drain D of the control TFT 11 is connected to a gate G of a TFT 12 as a drive transistor and to one terminal of a charge hold capacitor 13.

A source S of the drive TFT 12 is connected to the other terminal of the capacitor 13 and to a common anode 16 formed in the panel. Further, a drain D of the drive TFT 12 is connected to an anode of an organic EL device 14, and a cathode of the organic EL device 14 is connected to a common cathode 17 which constitutes, for example, a reference electric potential point (ground) formed in the panel.

FIG. 2 schematically shows a circuit arrangement including respective pixels 10 shown in FIG. 1 in a state that they are disposed to a display panel 20. The respective pixels 10 having the circuit arrangement shown in FIG. 1 are formed to the intersecting positions of respective scan lines A1 to An and respective data lines B1 to Bm. In the arrangement described above, the respective sources of the drive TFTs 12 are connected to a common anode 16 shown in FIG. 2, and the cathodes of the respective EL devices 14 are connected to a common cathode 17 shown in FIG. 2, likewise. Then, in the circuit, when an emission control is executed, a switch 18 is in a state grounded and connected as shown in the figure, thereby a voltage source+VD is supplied to the common anode 16.

In this state, when an on-voltage is supplied to the gate G of the control TFT 11 in FIG. 1 through the scan line, the TFT 11 causes a current corresponding to the voltage, which is supplied from the data line to the source S, to flow from the source to the drain D. Accordingly, the capacitor 13 is charged during a period in which the voltage of the gate G of the TFT 11 is turned on, the charged voltage is supplied to the gate G of the drive TFT 12, the TFT 12 causes a current based on the gate voltage and the source voltage thereof to flow from the drain D to the common cathode 17 through the EL device 14 to thereby emit the EL device 14.

Further, when the voltage of the gate G of the TFT 11 is turned off, the TFT 11 is made to a so-called cut off state, and the drain D of the TFT 11 is in opened state. However, the voltage of the gate G of the drive TFT 12 is kept by the charge accumulated to the capacitor 13, a drive current of the drive TFT 12 is maintained up to a next scan, and the emission of the EL device 19 is also maintained. Note that since the drive TFT 12 described above has a gate input capacitance, it is possible to make the drive TFT 12 to perform an operation similar to the above operation even if the capacitor 13 is not particularly provided.

Incidentally, there is a time gradation system as a system for displaying the actual gradation of pixel data using the circuit arrangement as described above. This time gradation system is a system for time dividing, for example, one frame period to a plurality of subframe periods and displaying intermediate gradation by the sum of subframe periods during which the organic EL devices are emitted during one frame period.

Further, this time gradation system has a method of emitting EL devices in a subframe unit and performing gradation expression by the simple sum of subframe period, during which emission is carried out (called a simple subframe method for the purpose of convenience) shown in FIG. 3 and a method of arranging blocks from one or a plurality of subframe periods, weighing the blocks by allocating a gradation bit thereto, and performing gradation expression by a combination of the blocks (called a weighted subframe method for the purpose of convenience) as shown in FIG. 4. Note that FIGS. 3 and 4 show an example when eight gradations from gradation 0 to gradation 7 are expressed.

Among them, the weighted subframe method is advantageous in that multi-gradation expression can be realized by the number of subframes smaller than that of the simple subframe method by also performing a weighting control for gradation expression also during a turned-on period of, for example, a subframe period.

However, in this weighted subframe method, since gradation is expressed by a discrete combination of emissions in a time direction to pixels of one frame, even if one gradation to be expressed is different from previous one, the center of gravity (offset of center of gravity in time of timing of emission) of emission may be greatly different. That is, when, for example, one gradation to be expressed by an adjacent pixel is different, contour-line noise called motion picture pseudo silhouette noise may occur and pixel quality is deteriorated thereby.

In contrast, in the simple subframe method, since emission during a plurality of subframe periods is not made largely discrete in emission during one frame period, occurrence of pseudo silhouette noise can be eliminated (pseudo silhouette noise does not occur). However, in the simple subframe method, since gradation is expressed by the emission simply performed during one or a plurality of continuous subframe periods, one frame period must be divided to many subframe periods to express multi-gradation expression. In this case, a high clock frequency must be set, from which a problem arises in that a load applied to a peripheral drive circuit is increased.

To cope with the above problems, Patent Document 1 discloses a method performing multi-gradation expression by combining actual gradation expression performed by a simple subframe method with area gradation (i.e., pseudo gradation) performed by a dither mask to perform the multi-gradation expression without increasing the number of subframes.

Patent Document 1: Japanese Patent Application Laid-Open Publication No. 2006-39030.

In the dither process, a plurality of (four in the example) pixels q, r, s, which are adjacent to each other up, down, right, and left, are arranged as one block, and dither coefficients 0 to 3 which are different from each other are allocated to the respective pixel data corresponding to the respective pixels of the block and added thereto, respectively as shown in, for example, FIG. 5. According to the example of the dither process, a combination of four intermediate expression levels is generated by four pixels. Accordingly, even if the bit number of pixel data is 4 bits (16 gradations), a luminance gradation level which can be expressed increases to four times, i.e., intermediate gradation equivalent to 6 bits (64 gradations) can be expressed. Therefore, in this case, a load applied to a peripheral drive circuit can be reduced because the simple subframe method can express actual gradation by 4 bit (16 gradations) even if it express 64 gradations.

Note that, in this dither process, since the area gradation is performed in a block unit having a plurality of pixels, dither pattern noise is liable to occur in the block unit. Accordingly, when, for example, 64 gradations are expressed by the dither mask (pseudo gradation) in addition to the actual gradation expression by 4 bit pixel data as described above, it is preferable to express the 64 gradations by switching one gradation value to be expressed between the actual gradation and the pseudo gradation in each frame or in each one scan line.

For example, tables of FIG. 6, shows an example of a method of gradation expression to be expressed in each odd frame and even frame (or each scan line). According to these tables, when even and odd frames (or scan lines) have the same gradation values to be expressed, the even and odd frames (or scan lines) do not express them only by the actual gradation or the pseudo gradation. That is, the odd frames (or odd scan lines) express the gradation by the actual gradation, and the even frames (or even scan lines) express the gradation by the pseudo gradation obtained by subjecting time gradation to the dither process.

Here, an emission pattern (emission period) in the frame (or scan line) whose gradation is expressed by, for example, the pseudo gradation is made longer or shorter than the emission pattern in the frame (or scan line) whose gradation is expressed only by the actual gradation. That is, even if expression is performed by the same gradation value, since a substantial emission time is different between continuous frames (or scan lines), noise or a flicker phenomenon caused by a dither pattern can be reduce.

Incidentally, in a time gradation system performed by the simple subframe method, the ratio of length of the emission periods during respective subframe periods (SF) is preferably set different as shown in FIG. 7 (when seven subframes exist) in consideration of more natural gradation expression. The ratio of length of the emission periods (duty ratio) is determined so that a luminance curve between respective gradations has a nonlinear shape (for example, gamma (γ) value is 2) as shown in a graph of FIG. 8. Accordingly, since the gradation expressed by the simple subframe method can be provided with nonlinear characteristics (gamma characteristics), more natural gradation expression can be realized.

As described above, the emission periods are controlled by preferably turning off EL devices after they are emitted during respective subframes period as shown in FIG. 7.

Accordingly, in an arrangement of the pixel 10 shown in FIG. 1, output sides of erase drivers 33 are connected to scan lines A1 to An, the scan lines A1 to An are shared by pixel data writing scanning and erase data writing scanning, and data lines B1 to Bm are also shared by the pixel data and the erase data as shown in FIG. 9. Writing of the pixel data and writing of the erase data are switched by controlling an enable signal EN1 for supplying a scan control signal G1 to the scan lines A1 to An and an enable signal EN2 for supplying an erase control signal G2 to the scan lines A1 to An.

In this arrangement, as shown in a timing chart of FIG. 10, after the pixel data supplied by a data driver 31 is written at a scan control timing from a write driver 32 during one scan period, an erase driver 33 performs a write control of erase data. That is, in the circuit arrangement shown in FIG. 9, since a write operation and an erase operation to the scan lines A1 to An cannot be performed at the same timing temporally, both the operations are controlled so that they do not overlap. As a result, it is possible to perform an operation for turn off pixels while they are being turned on in one subframe period.

Here, an example, in which an emission period is set to two scan periods, will be explained using FIG. 10. During a first scan period, pixel data is written to a line A1, and no erase data is written. At the time, the line A1 is turned on. During a second scan period, pixel data is written to a line A2, and no erase data is written. At the time, the lines A1, A2 are turned on. During a third scan period, pixel data is written to a line A3, and no erase data is written. At the time, the lines A1, A2, A3 are turned on. Then, during a fourth scan period, pixel data is written to a line A4 and erase data is written to the line A1. At the time, the lines A2, A3, A4 are turned on. That is, the line A1 is turned on for two scan periods and then turned off. As described above, all the lines A1 to An are turned on during the two scan periods by sequentially performing the write operation and the erase operation.

Note that although the erase control is performed after the write control in FIG. 10, the write control may be performed to control after the erase control inversely. That is, even in such arrangement, an operation for turning off the pixels while they are being turned on can be performed.

Otherwise, the circuit arrangement of the respective pixels may be arranged as shown by a pixel 30 shown in FIG. 11. That is, the circuit is arranged by adding a TFT 15 as an erase transistor for erasing a charge accumulated in a capacitor 13 to the circuit arrangement of the pixel 10 shown in FIG. 1.

The erase TFT 15 is connected in parallel to the capacitor 13 and turned on in response to a control signal from a drive control circuit (not shown) while an organic EL device 14 is turned on so that the charge of the capacitor 13 can be instantly discharged. With this operation, the pixels can be turned off until they are addressed next.

In the arrangement of the pixels 30, control lines C1 to Cn for supplying the control signal to the erase TFT 15 are connected to an output side of the erase driver 33 as shown in FIG. 12. Then, as shown in a timing chart of FIG. 13, a turn-off operation is performed by the erase driver 33 while data is written under the control of the write driver 32 during one scan period.

### DISCLOSURE OF THE INVENTION

### Problems to be Solved by the Invention

As described above, noise and a flicker phenomenon caused by a dither pattern can be effectively reduced by performing a control for switching the emission patterns (gradation expression only by the actual gradation and gradation expression by the pseudo gradation) of each scan line.

However, when the control method for switching the emission patterns in each scan line is applied to the drive circuits shown in FIGS. 9 and 12, the following problem arises.

That is, when the emission patterns are different in each scan line, the emission periods of the pixels on the odd scan lines and the even scan lines are different from each other in one subframe period as shown in FIG. 14. When the emission control is realized by the drive circuits shown in FIGS. 9 and 12, according to the arrangement of the erase driver 33, the pixels on both the odd and even scan lines are turned off at the same timing. Accordingly, a turning-off operation must be performed once between adjacent scan lines according to a timing of a shorter emission pattern (emission period) and a remaining emission operation must be performed in a next subframe as shown in FIG. 15. That is, one subframe is additionally necessary to express one gradation, from which a technical problem arises in the increased of subframes.

An object of the present invention, which was made in view of the above technical problems, is to provide a pixel driving apparatus and a pixel driving method for time dividing one frame period to a plurality of subframe periods and performing gradation expression by the sum of the turned-on periods of one or a plurality of subframe periods to suppress occurrence of noise caused by the gradation expression without increasing the number of subframes.

### Means for Solving the Problems

In a pixel driving apparatus according to the present invention, which was made to solve the above problems and has a plurality of pixels disposed in the intersecting positions of a plurality of data lines and a plurality of scan lines and turned on by that pixel data signals are written thereto and in which the plurality of pixels are divided to at least two scan groups depending on a period from writing of the pixel data signals to erasing thereof, the pixel driving apparatus has a data line drive means for supplying the pixel data signals to the data lines, a scan line drive means for scanning the scan lines so that the pixel data signals supplied to the data lines by the data line drive means are written to the pixels, and an erase scan means for erasing the pixel data signals written to pixels by the scan line drive means in each of the scan groups.

Further, in a pixel driving method according to the present invention, which was made to solve the above problems and has a plurality of pixels disposed in the intersecting positions of a plurality of data lines and a plurality of scan lines and turned on by that pixel data signals are written thereto, wherein the plurality of pixels are divided to at least two scan groups depending on a period from writing of the pixel data signals to erasing thereof, the pixel driving method, that the pixel data signals are supplied to the data lines, the scan lines are scanned so that the pixel data signals supplied to the data lines are written to the pixels, and the pixel data signals written to the pixels are erased in each of the scan groups.

### BRIEF DESCRIPTION OF THE DRAWINGS

FIG. 1 is a view showing an example of a circuit arrangement corresponding to one pixel in a conventional active matrix type display panel;

FIG. 2 is a view schematically showing the circuit arrangement having respective pixels shown in FIG. 1 in a state that they are disposed to a display panel;

FIG. 3 is a timing chart explaining a simple subframe method in a time gradation system;

FIG. 4 is a timing chart explaining a weighted subframe method in the time gradation system;

FIG. 5 is a view explaining a dither process;

FIG. 6 is correspondence tables of the number of gradations preferable for reducing expression noise and a gradation expression method;

FIG. 7 is a view showing an emission time ratio in a plurality of subframe periods when nonlinear characteristics are taken into consideration;

FIG. 8 is a graph showing nonlinear gradation characteristics;

FIG. 9 is a view showing an arrangement example of a drive circuit when the circuit arrangement as shown in FIG. 1 is driven;

FIG. 10 is a view showing timings at which data is written and erased by the drive circuit shown in FIG. 9;

FIG. 11 is a view showing a pixel circuit arrangement when an erase transistor is used;

FIG. 12 is a view showing an arrangement example of a drive circuit when a circuit arrangement as shown in FIG. 11 is driven;

FIG. 13 is a view showing timings at which data is written and erased by the drive circuit shown in FIG. 12;

FIG. 14 is a view explaining an emission period of each scan line when a different emission pattern is used between the odd scan lines and the even scan lines;

FIG. 15 is a view explaining a gradation expression of each scan line controlled by a conventional drive circuit;

FIG. 16 is a block diagram showing an overall arrangement of a pixel driving apparatus of the present invention;

FIG. 17 is a view showing an emission period during a subframe period of the odd scan lines and the even scan lines in the driving apparatus of FIG. 16;

FIG. 18 is a graph showing preferable gradation characteristics in the odd scan lines and the even scan lines;

FIG. 19 is a view showing an arrangement of a drive circuit of a first embodiment of the present invention;

FIG. 20 is a view showing write and erase timings in the drive circuit of FIG. 19;

FIG. 21 is a view showing an arrangement of a drive circuit of a second embodiment of the present invention;

FIG. 22 is a view showing write and erase timings in the drive circuit of FIG. 21;

FIG. 23 is a view showing an arrangement of a drive circuit of a third embodiment of the present invention;

FIG. 24 is a view showing write and erase timings in the drive circuit of FIG. 23;

FIG. 25 is a view showing an arrangement of a drive circuit of a fourth embodiment of the present invention;

FIG. 26 is a view showing write and erase timings in the drive circuit of FIG. 25;

FIG. 27 is a view showing an arrangement of an erase driver of a fifth embodiment of the present invention; and

FIG. 28 is a view showing an example of an emission pattern in a pixel driving apparatus of the present invention.

### EXPLANATION OF REFERENCE NUMERALS

11 control TFT
12 drive TFT
13 capacitor
14 organic EL device
15 erase TFT
21 drive control circuit
22 A/D converter
23 frame memory
24 data driver
25 write driver
26 erase driver
28 data conversion means
30 pixel
40 display panel
A scan line
B data line
C control line

### BEST MODE FOR CARRYING OUT THE INVENTION

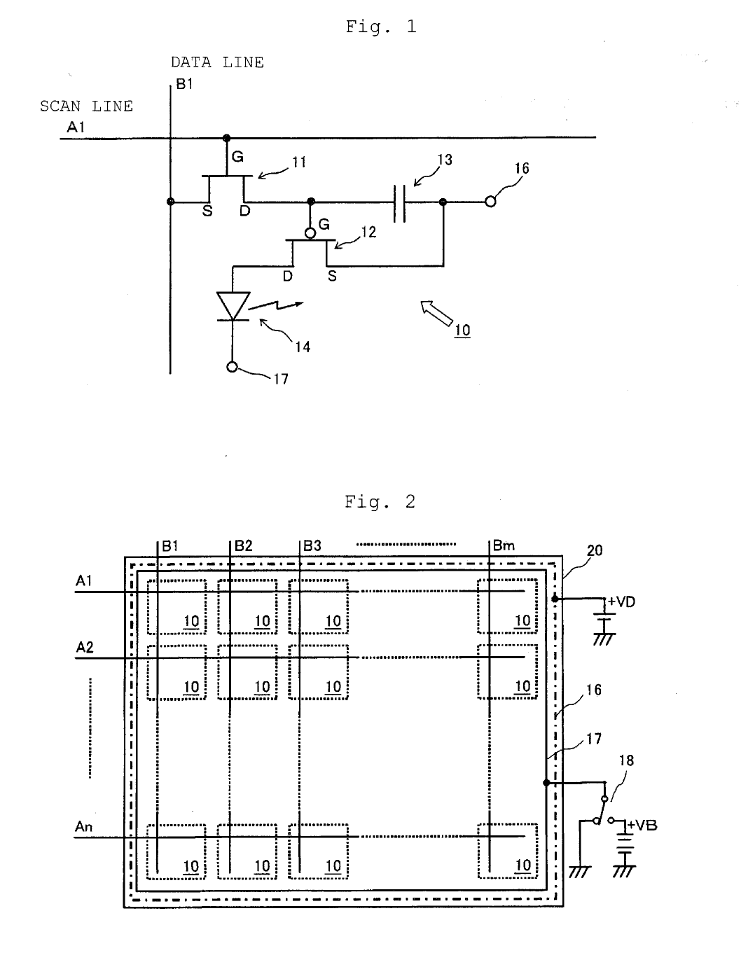

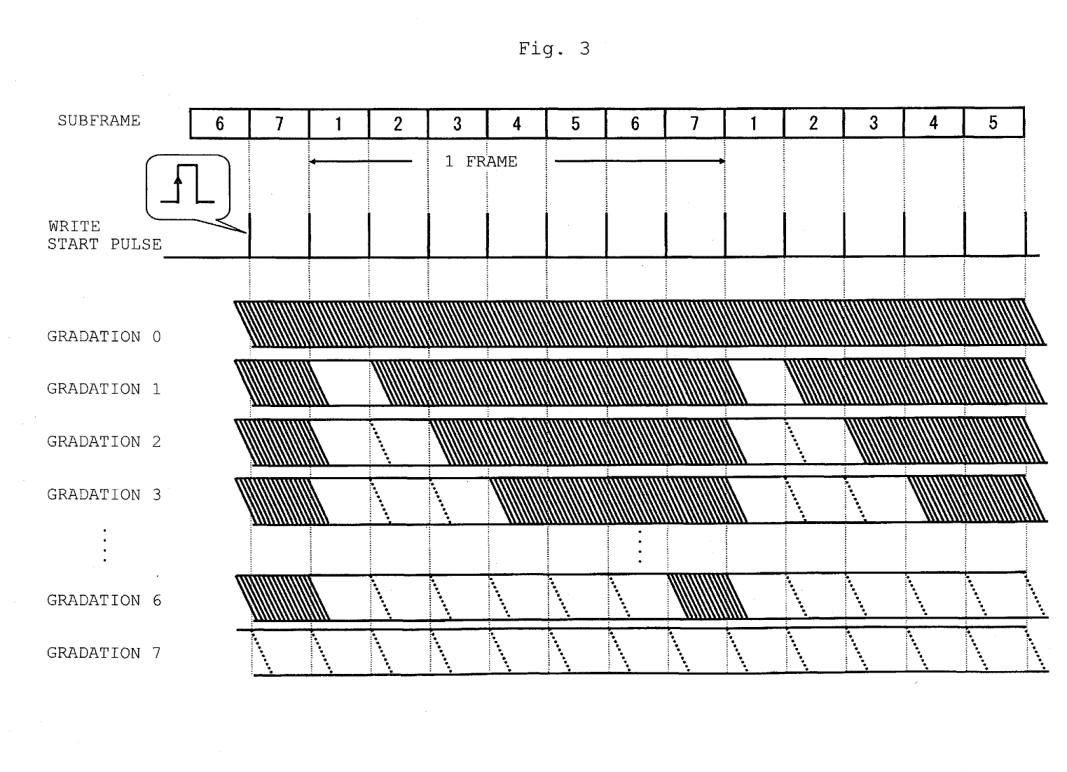

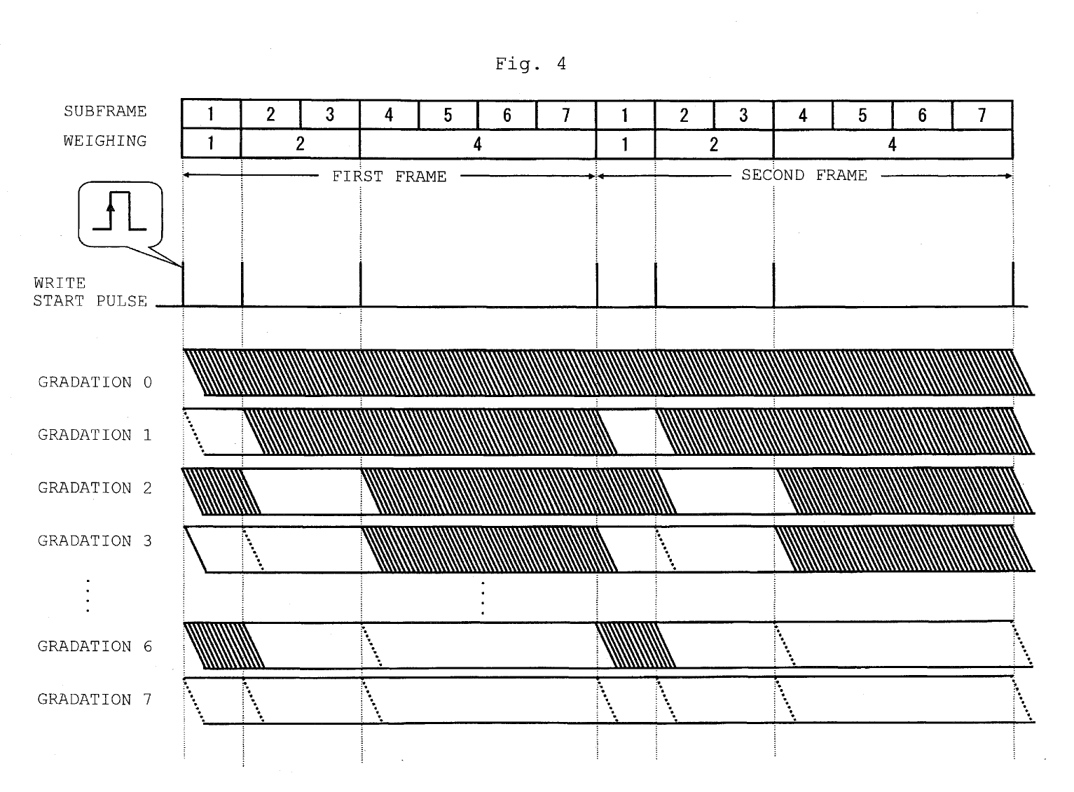

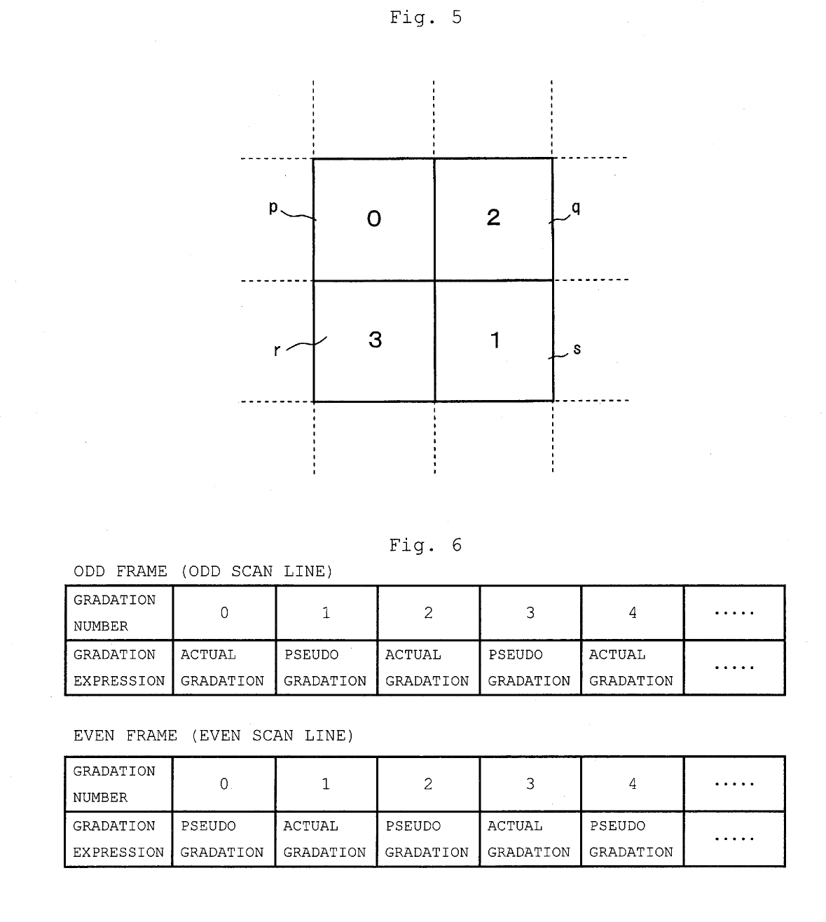

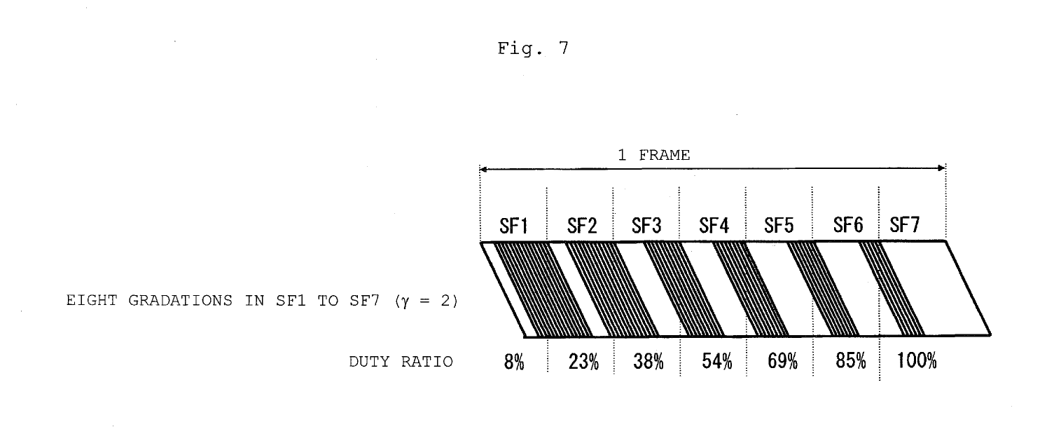

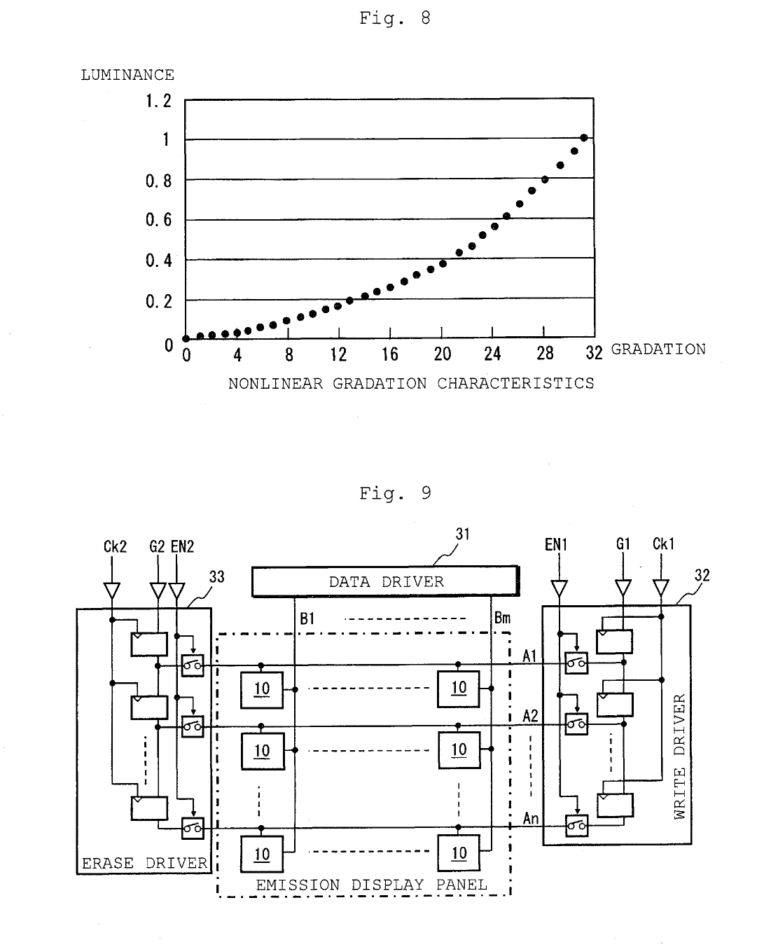

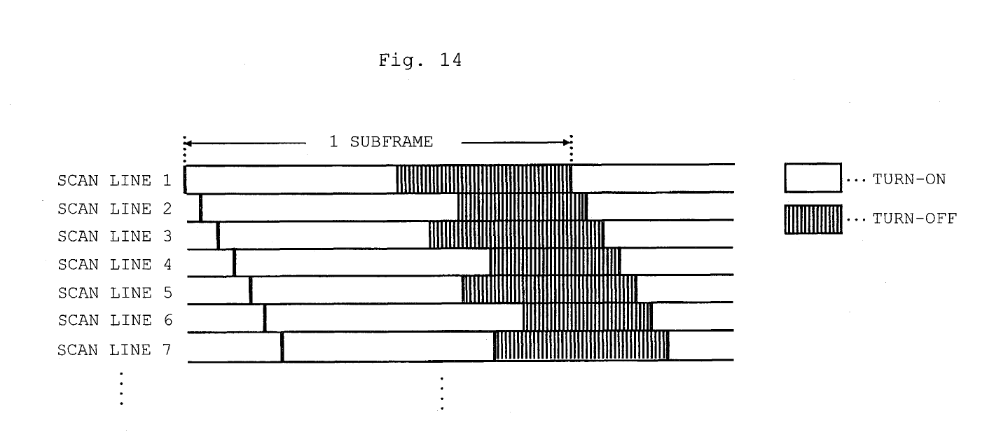

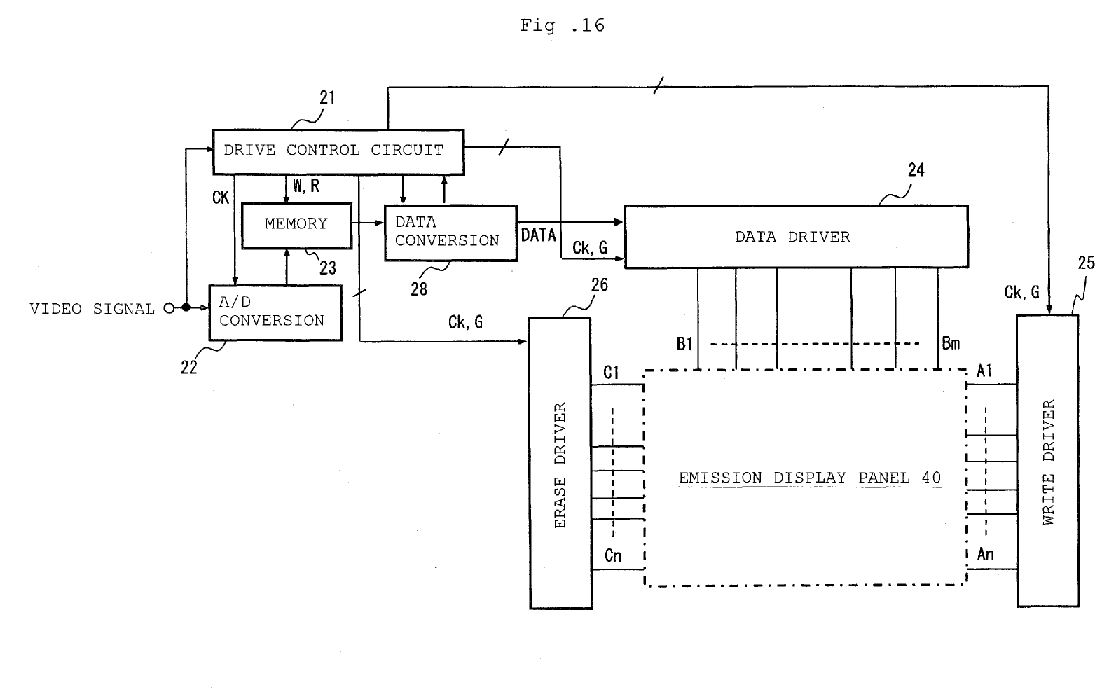

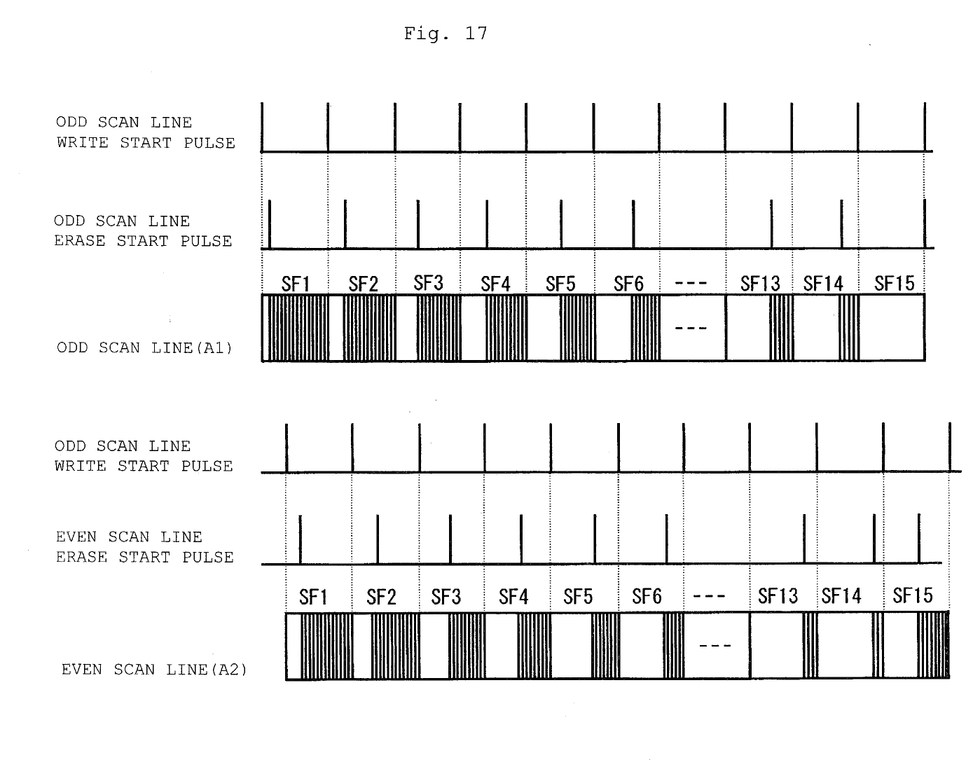

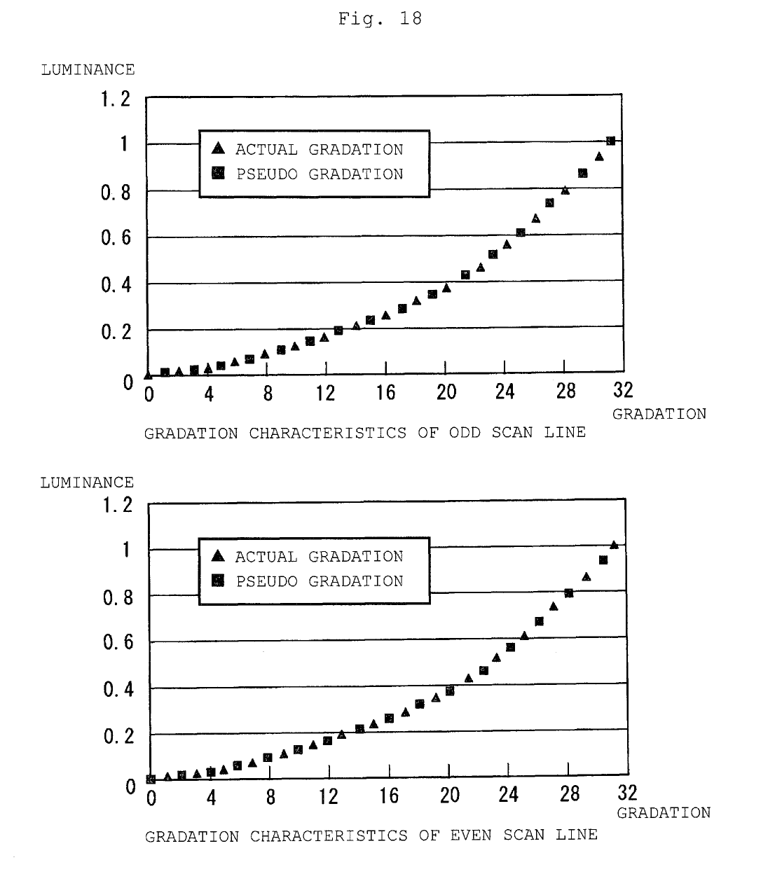

A pixel driving apparatus and a pixel driving method according to the present invention will be explained below based on embodiments shown in the figures. Note that in the explanation described below, the portions corresponding to the respective portions shown in FIGS. 1 to 15 described already are denoted by the same reference numerals, and the explanation of the respective functions and the operations of the portions are appropriately omitted.

Further, the conventional example shown in FIGS. 1 to 15 shows an example of a so-called monochromatic emission display panel in which all the series circuits of the drives TFT 12 and the EL devices 14, which constitute pixels, are connected between the common anode 16 and the common cathode 17. However, in the pixel driving apparatus according to the present invention explained below is rather suitably employed to a color display panel having respective R (red), G (green), B (blue) emission pixels (subpixels) in addition to a monochromatic emission display panel.

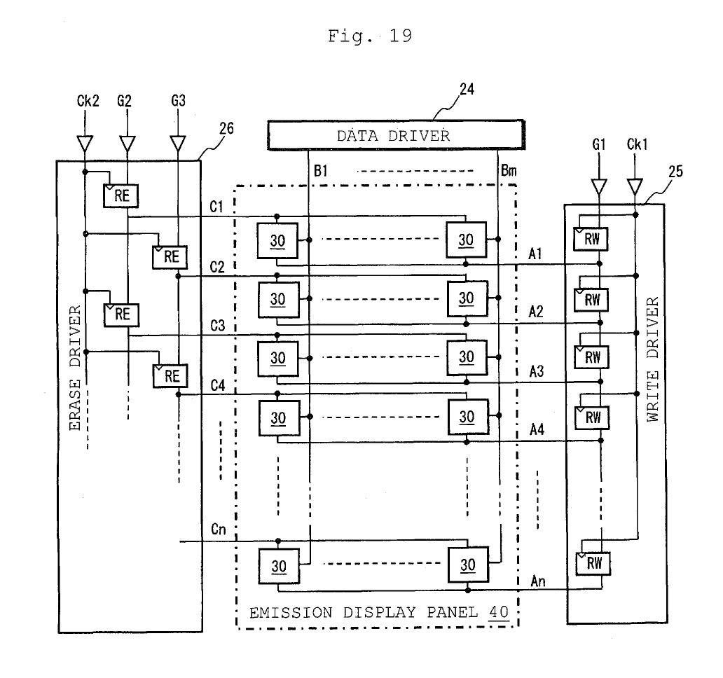

FIG. 16 is a view showing a first embodiment of the pixel driving apparatus according to the present invention and shows an overall arrangement thereof by a block diagram.

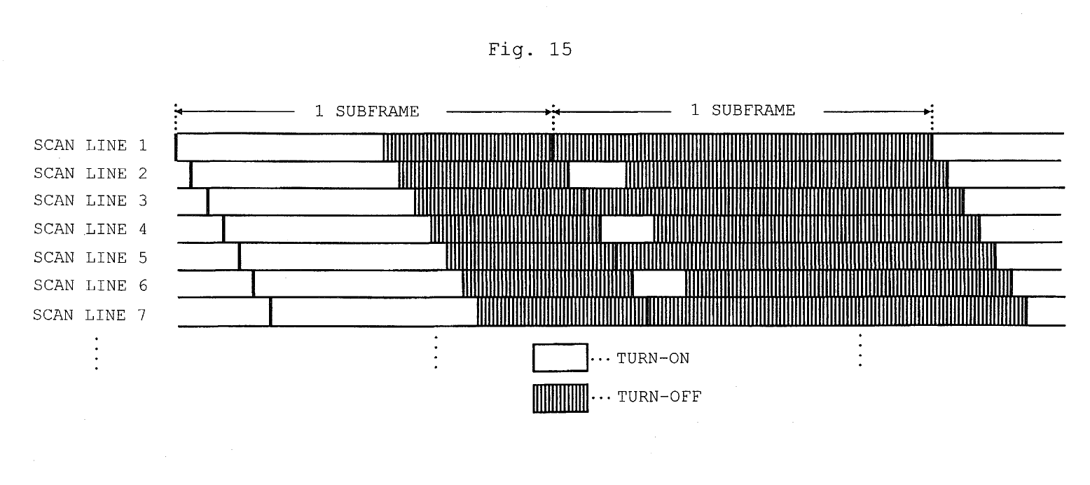

In FIG. 16, a drive control circuit 21 controls an operation of an emission display panel 40 consists of a data driver 24 (data line drive means), a write driver 25 (scan line drive means), an erase driver 26 (scan means for erasing), and pixels 30 disposed in matrix (i.e., a pixel arrangement shown in FIG. 11).

First, input analog video signals are supplied to the drive control circuit 21 and to an analog and digital (A/D) converter 22. The drive control circuit 21 creates a clock signal CK to the A/D converter 22 and a read-out signal R and a write signal W to a frame memory 23 based on a horizontal synchronization signal and a vertical synchronization signal in the analog video signals.

The A/D converter 22 acts to sample the input analog video signals based on the clock signal CK supplied from the drive control circuit 21, to convert the sampled analog video signals to pixel data corresponding to each one pixel, and to supply the pixel data to the frame memory 23. The frame memory 23 operates to sequentially write the pixel data supplied from the A/D converter 22 in response to the write signal W from the drive control circuit 21, to the frame memory 23.

When data for one screen (n rows×m columns) of the self-emission display panel 40 has been written by the write operation, the frame memory 23 sequentially supplies the data of each one pixel to a data conversion means 28 as for example 6 bit pixel data in response to a read-out signal R supplied from the drive control circuit 21.

The data conversion means 28 subjects the 6 bit pixel data to a multi-gradation process such as a dither process, converts the 6 bit pixel data to 4 bit pixel data, and supplies the 4 bit pixel data of each one row from a first row to an n-th row to the data driver 24.

In contrast, a timing signal is delivered to the write driver 25 by the drive control circuit 21, and the write driver 25 sequentially delivers a gate-on voltage to respective scan lines based on the timing signal. Accordingly, the drive pixel data of each one row, which is read out from the frame memory 23 and subjected to the data conversion by the data conversion means 28, is addressed for each row thereof by the scan of the write driver 25.

Further, the first embodiment is arranged such that a control signal is delivered from the drive control circuit 21 to the erase driver 26.

On receiving the control signal from the drive control circuit 21, the erase driver 26 selectively applies a predetermined voltage level to electrode lines (in the embodiment, called control lines C1 to Cn) which are disposed by being electrically separated in each scan line as shown in FIG. 11 and controls an turn on and off operation of an erase TFT 15.

Incidentally, since the circuit arrangement described above can change the supply time (turn-on time) of a drive current applied to the EL devices as light-emitting devices, it can control the substantial emission luminance of the organic EL devices 14. Accordingly, the gradation expression in the pixel driving apparatus according to the present invention, a time gradation system is fundamental. A simple subframe method is applied as the time gradation system to completely suppress occurrence of the motion picture pseudo silhouette noise described above and occurrence of abnormal gradation. Note that a control signal G for writing and erasing pixel data to the pixels 30 for realizing time gradation is created by the drive control circuit 21 (gradation expression means).

Further, in the driving device, the data conversion circuit 28 (gradation expression means) performs data conversion processes, i.e., mainly the dither process to realize a more multi-gradation expression by a smaller number of subframes. That is, there is used a method of expressing the multi-gradation by the smaller number of subframes by expressing actual gradation by the time gradation and expressing pseudo gradation by the dither process.

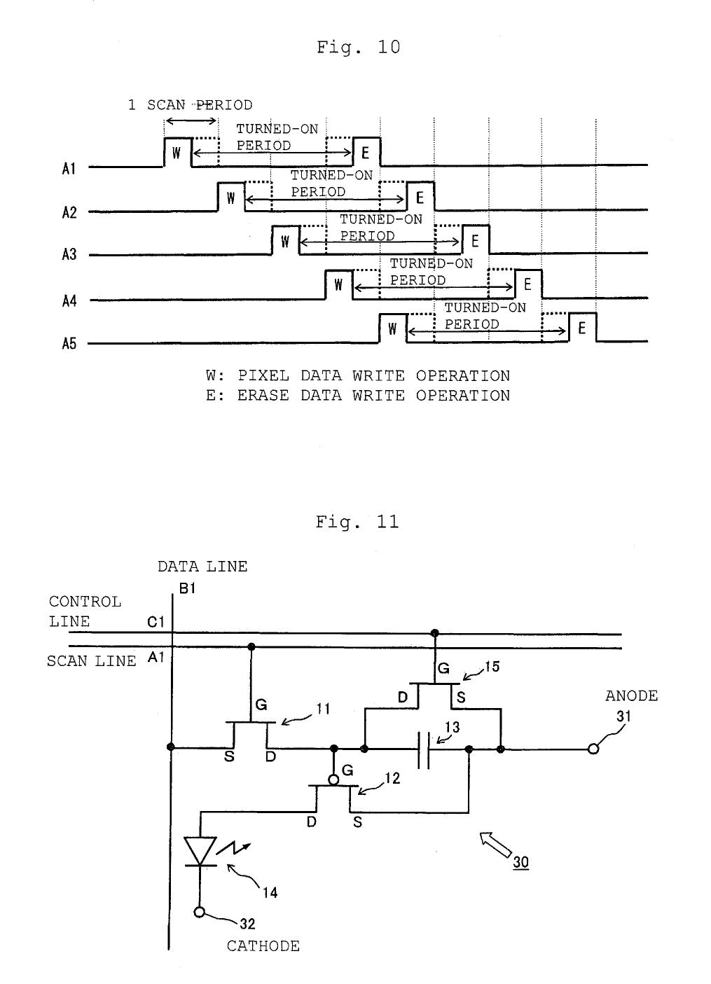

In this case, as shown in FIG. 17, all the ratios of emission periods during respective subframes (SF1 to 15) in the odd scan lines and the even scan lines are made different from each other. At the time, the length of the emission period in the respective subframe periods is determined so that it is made nonlinear as in a luminance curve between respective gradations shown by the simple subframe method in FIG. 8. Accordingly, since gradation expressed by the simple subframe method can be provided with nonlinear characteristics (gamma characteristics), more natural gradation expression is realized. Note that the emission period in the respective subframe periods is created in such a manner that the erase TFT 15 is driven in response to an erase start pulse supplied from the erase driver 26 based on the control signal from the drive control circuit 21 and the charge of the capacitor 13 is instantly discharged.

Further, as shown in the figure, the emission period of the odd scan lines is made shorter than that of the even scan lines as to the subframe periods having the same numbers except SF15. That is, the plurality of pixels 30 on the display panel 40 are divided to at least two scan groups depending on a period during which a data signal is written and erased. For example, the emission period of the odd scan line in SF3 is set to an approximately medium length of the emission periods of even scan lines in SF2 and SF3. That is, offset of luminance expressed between scan lines is adjusted in such a manner that the emission period of the data of the odd scan line whose value is converted to a value larger than that of the data of the even scan line by the data conversion circuit 28 is set shorter than that of the even scan line.

Accordingly, when the values of the pixel data input from the frame memory 23 have the same values in the even scan lines and in the odd scan lines, expressed gradation is actually different in the respective scan lines. However, since emission periods are different between adjacent scan lines, gradation is naturally expressed without causing an offset of luminance in the sense of sight. Note that as to SF15, the emission period in the odd scan line is set longer than that of the even scan line so that the even scan lines and the odd scan lines have the same emission period in an entire one frame.

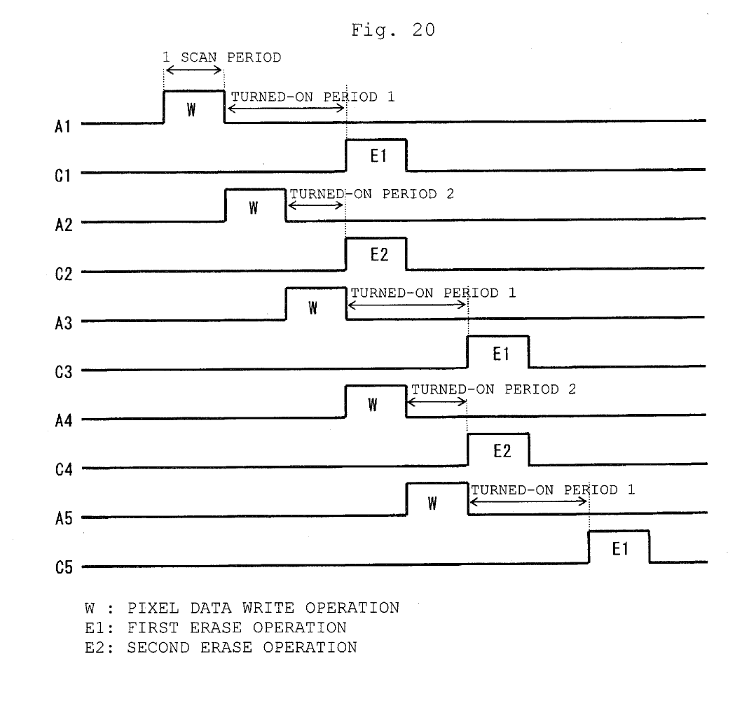

In the embodiment according to the present invention, when certain one gradation is expressed, it is neither expressed only by actual gradation nor only by pseudo gradation in both the even and odd scan lines and expressed only by the actual gradation in the odd scan lines and expressed by the pseudo gradation resulting from the dither process in the even scan lines as shown in a graph of nonlinear gradation characteristics of FIG. 18 to further reduce pattern noise and a flicker phenomenon caused by the dither process.

Further, when the gradation is expressed by the actual gradation and the pseudo gradation as described above, it is preferable to control a turn-on drive in the respective pixels so that the odd frames and the even frames (that is, each of the frames) have a different emission pattern (for example, expression by the actual gradation in the odd frames, and expression by the pseudo gradation in the even frames, and the like).

In addition to the above-mentioned, the emission patterns obtained by the gradation expression method may be different from each other even in the same frame depending on the emission color of the pixels.

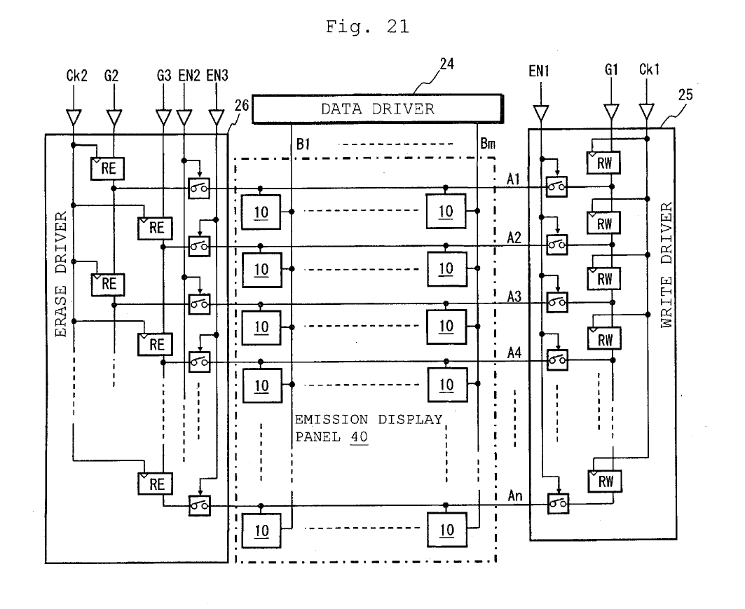

In the driving device according to the present invention, the write driver 25 and the erase driver 26 are arranged as shown in a block diagram of FIG. 19 to realize such gradation expression. That is, in the write driver 25, pixel data is written and scanned to the respective scan lines A1 to An by a register circuit RW based on a scan control signal G1 from the drive control circuit 21 in synchronization with a clock signal CK1.

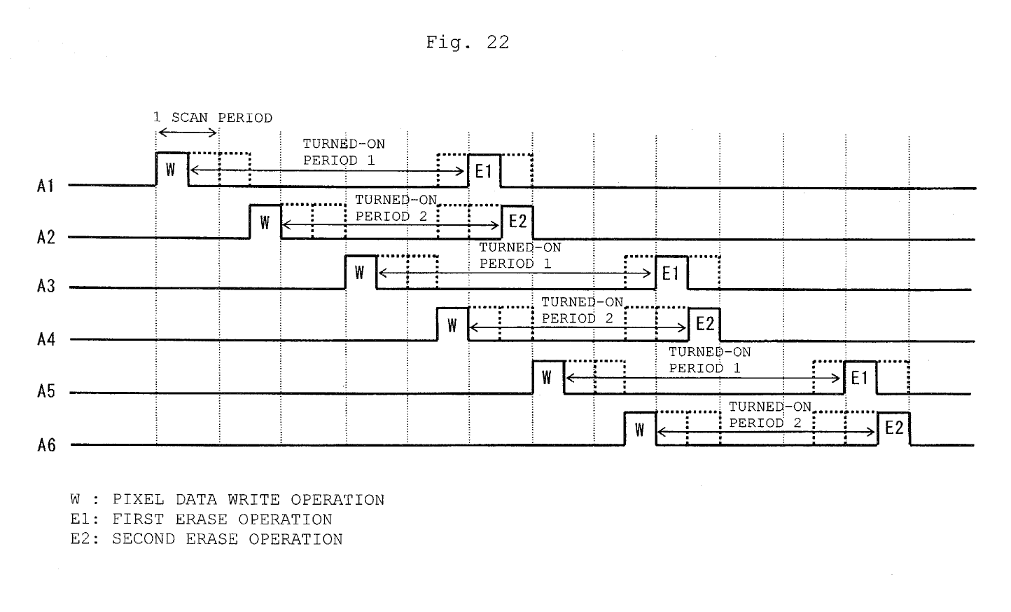

In contrast, two erase control signals G2 and G3 and a clock signal CK2 (whose frequency is one-half of the clock signal CK1) are input from the drive control circuit 21 to the erase driver 26. Register circuits RE, which operate to the respective scan lines based on the clock signal CK2, are provided in the erase driver 26. The erase control signal G2 is input to the register circuits RE corresponding to the odd scan lines as data, and the erase control circuit G3 is input to the register circuits RE corresponding to the even scan lines as data. Accordingly, with this arrangement, even if the emission patterns of the respective scan lines are different, it is possible to control the even scan lines and the odd scan lines so that they have different emission periods (turned-on periods) in one subframe period as shown in a timing chart of FIG. 20, and thus an increase of the number of the subframes can be suppressed. Note that, in the circuit arrangement, the odd scan lines and the even scan lines are turned off every other one scan in the same scan period (E1 and E2 are overlapped in the figure) as shown in FIG. 20.

As described above, according to the first embodiment of the present invention, the pixels are turned off at independent timings, respectively in the odd scan lines and the even scan lines. With this operation, even if the periods, during which the pixels in the odd scan lines and the pixels in the even scan lines are to be turned on, are different, the pixels can be turned off at different timings in the same subframe periods thereof. Accordingly, since conventionally required extra subframe periods are not necessary, noise caused when gradation is expressed can be reduced without increasing the number of subframes.

Subsequently, a second embodiment of the pixel driving apparatus and the pixel driving method according to the present invention will be explained. The second embodiment is different from the overall arrangement of the driving apparatus of the first embodiment shown in FIG. 16 in that scan lines A1 to An from a write driver 25 are used as control lines for transmitting a control signal from an erase driver 26. Accordingly, in the second embodiment, illustration of the overall arrangement of the driving apparatus is omitted.

Further, in the second embodiment, since the scan lines A1 to An from the write driver 25 are used as the control lines for transmitting the control signal from the erase driver 26, the arrangement of the pixel 10 shown in FIG. 1 is employed.

Further, the same gradation display method as that of the first embodiment is also employed in the second embodiment. To reduce noise caused by the gradation expression, a control is performed to make emission patterns (emission periods) different during a subframe period of respective scan lines even in the same gradation number expression.

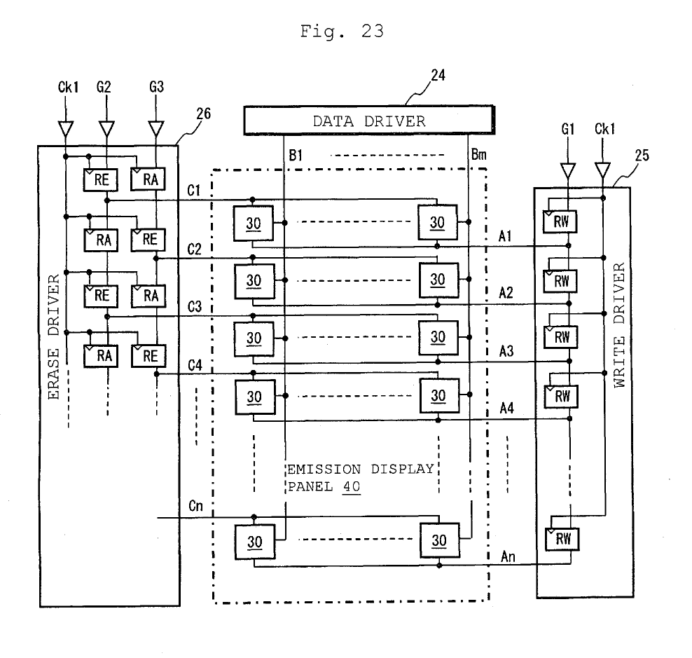

FIG. 21 shows arrangements of the write driver 25 and the erase driver 26 in the second embodiment. As shown in the figure, the write driver 25 is arranged such that pixel data is written and scanned to the respective scan lines A1 to An by a register circuit RW based on a scan control signal G1 in synchronization with a clock signal CK1.

In contrast, two erase control signals G2 and G3 and a clock signal CK2 are input to the erase driver 26 from a drive control circuit 21. Register circuits RE, which operate to respective scan lines based on a clock signal CK2, are provided in the erase driver 26. The erase control signal G2 is input to the register circuits RE, which correspond to odd scan lines as data, and the erase control signal G3 is input to the register circuits RE, which correspond to the even scan lines as data. That is, in the circuit arrangement, the pixels 10 are independently turned off on the odd scan lines and on the even scan lines.

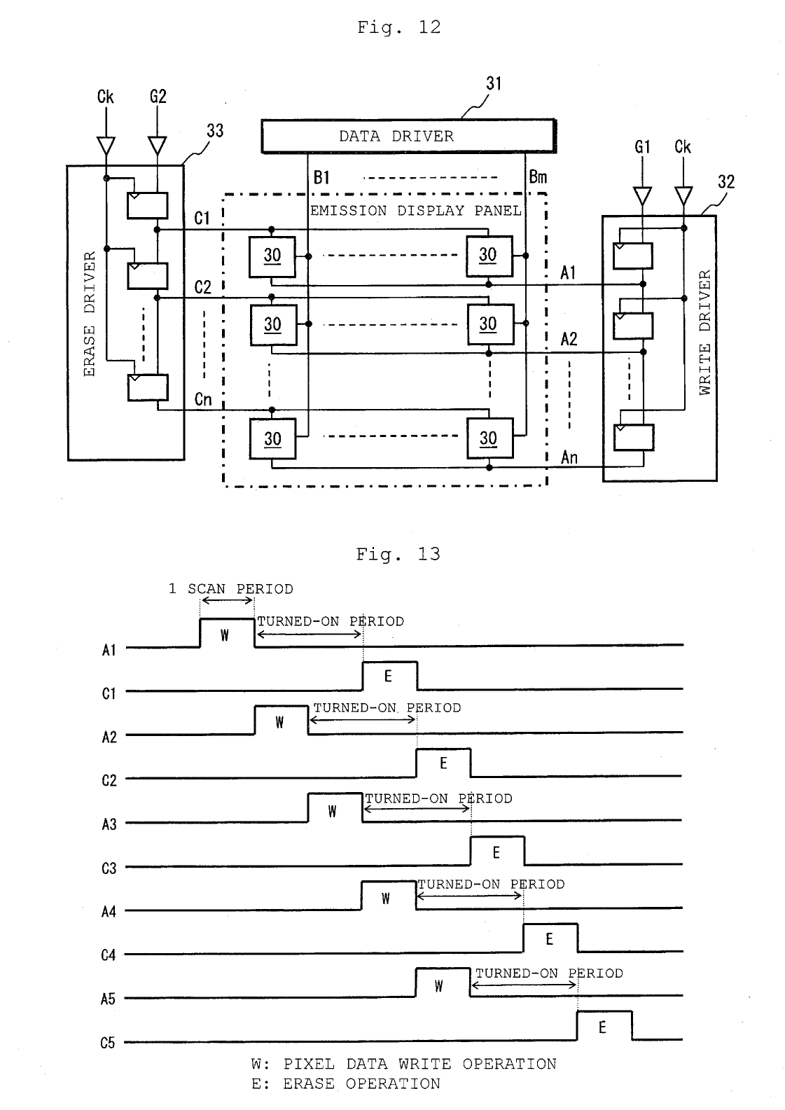

Note that, in the circuit arrangement, the scan lines A1 to An are shared by a pixel data write scan and an erase data write scan, and data lines B1 to Bm are also shared by pixel data and erase data likewise the circuit arrangement of FIG. 9. Accordingly, writing of the pixel data and writing of the erase data are switched by controlling an enable signal EN1 for supplying the scan control signal G1 to the scan lines A1 to An, an enable signal EN2 for supplying the erase control signal G2 to the scan lines A1, A3, A5, . . . , and an enable signal EN3 for supplying the erase control signal G3 to the scan line A2, A4, A6, . . . .

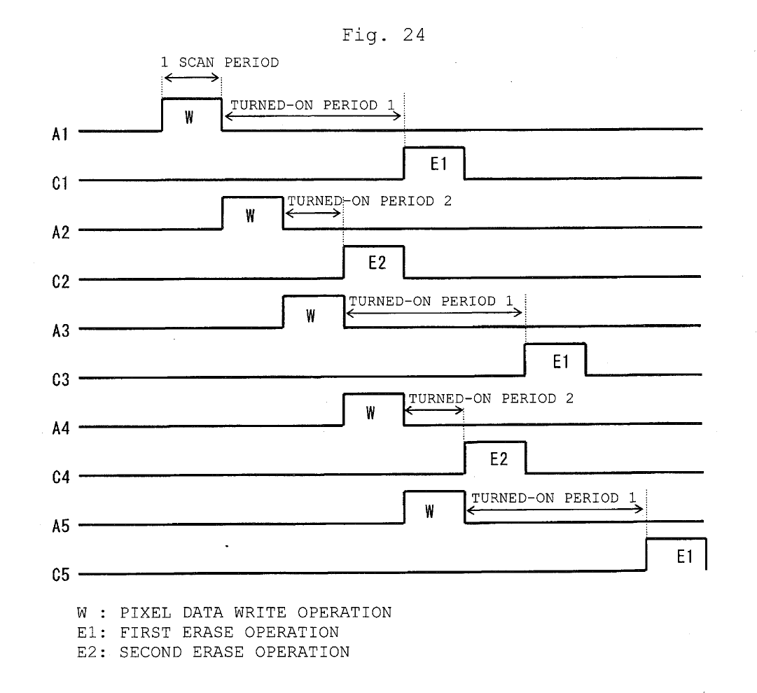

In the circuit arrangement, when the control is performed to make emission patterns (emission periods) during the subframe period different in the odd scan lines and in the even scan lines, the control is performed as shown in a timing chart of FIG. 22. That is, as shown in the figure, the signals G1, G2, G3 are supplied to the respective pixels 10 every other one scan period at the timings at which the control timings of the write scan and the erase scan are not overlapped in one scan period (in the figure, W, E1, E2 are not overlapped between the scan lines) to use the same scan lines A1 to An to transmit the scan control signal G1 from the write driver 25 and to transmit the erase control signals G2 and G3 from the erase driver 26.

According to the second embodiment of the present invention, the pixels are turned off at independent timings, respectively in the odd scan lines and the even scan lines likewise the first embodiment described above. With this operation, even if the periods, during which the pixels are to be turned on, are different in the odd scan lines and in the even scan lines in the same subframe periods, the pixels can be turned off at different timings in the subframe periods. Accordingly, noise caused in gradation expression can be reduced without requiring conventionally required extra subframe period and without increasing the number of subframes.

Subsequently, a third embodiment of the pixel driving apparatus and the pixel driving method according to the present invention will be explained. This third embodiment is different from the overall arrangement of the driving apparatus of the first embodiment shown in FIG. 16 only in that a clock signal supplied to an erase driver 26, a clock supplied to a write driver 25, and a clock supplied to the erase driver are a common clock. Accordingly, in this third embodiment, illustration of the overall arrangement of the driving apparatus is omitted.

Further, the same gradation display method as that of the first embodiment is also employed in the third embodiment. To reduce noise caused by the gradation expression, a control is performed to make emission patterns (emission periods) different during a subframe period of respective scan lines even in the same gradation number expression.

FIG. 23 shows arrangements of the write driver 25 and the erase driver 26 in the third embodiment. As shown in the figure, the write driver 25 is arranged such that pixel data is written and scanned to the respective scan lines A1 to An by a register circuit RW based on a scan control signal G1 in synchronization with a clock signal CK1.

In contrast, two erase control signals G2 and G3 and a clock signal CK1 (common to a clock signal to the write driver 25) are input to the erase driver 26 from a drive control circuit 21. Register circuits RE, which operate to respective scan lines based on the clock signal CK1, are provided in the erase driver 26. An erase control signal G2 is input to the register circuits RE, which correspond to odd scan lines as data, and an erase control signal G3 is input to the register circuits RE which corresponds to even scan lines as data. At the time, as shown in the figure, since adjustment register circuits RA are provided in front of the register circuits RE except the scan line A1 as a leading line, the clock signal CK1 for supplying the scan control signal G1 from the write driver 25 can be commonly used.

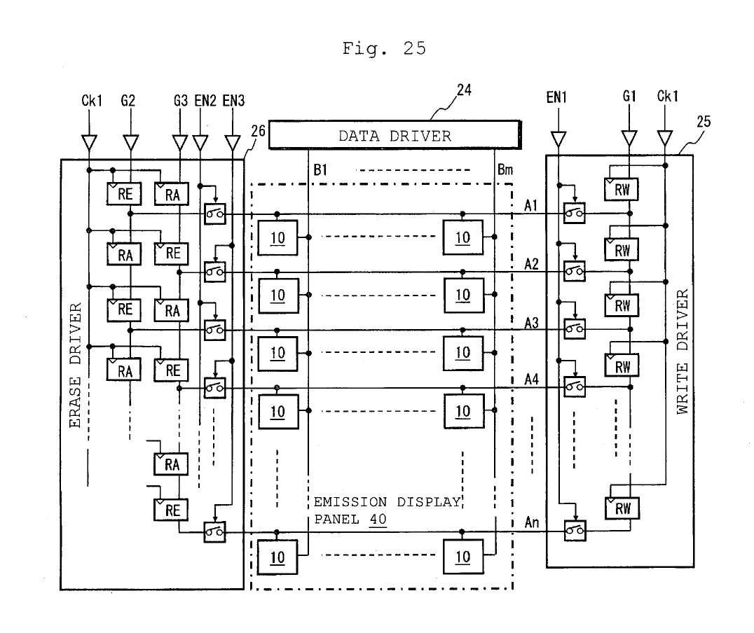

In the circuit arrangement, the pixels 30 on the odd scan lines and on the even scan lines are independently turned off. When a control is performed to make emission patterns (emission periods) during a subframe period different in the odd scan lines and in the even scan lines, the control is performed as shown in a timing chart of FIG. 24. That is, each time a write operation is performed by the write driver 25, a control of the emission periods (turned-on periods) in the odd scan lines based on the erase control signal G2 (E1 in the figure) and a control of the emission periods (turned-on periods) in the even scan lines based on the erase control signal G3 (E2 in the figure) are alternately performed.

As described above, according to the third embodiment of the present invention, since the clock signal in the write driver 25 and the erase driver 26 can be made to a common signal, and further the same effect as that of the first embodiment can be obtained.

Subsequently, a fourth embodiment of the pixel driving apparatus and the pixel driving method according to the present invention will be explained. As shown in FIG. 25, the fourth embodiment is different from the third embodiment in that scan lines A1 to An from a write driver 25 are used as control lines for transmitting a control signal from an erase driver 26 and that the arrangement of the pixel 10 shown in FIG. 1 is employed as pixels.

Accordingly, writing of the pixel data and writing of erase data are switched by controlling an enable signal EN1 for supplying a scan control signal G1 to the scan lines A1 to An, an enable signal EN2 for supplying an erase control signal G2 to the scan lines A1, A3, A5, . . . , and an enable signal EN3 for supplying an erase control signal G3 to the scan line A2, A4, A6, . . . .

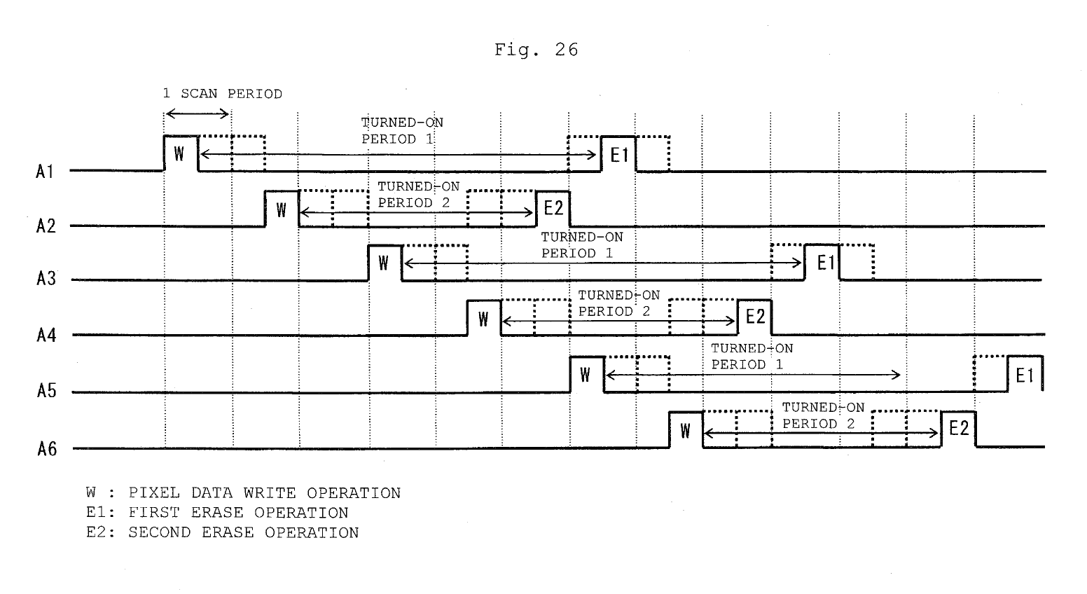

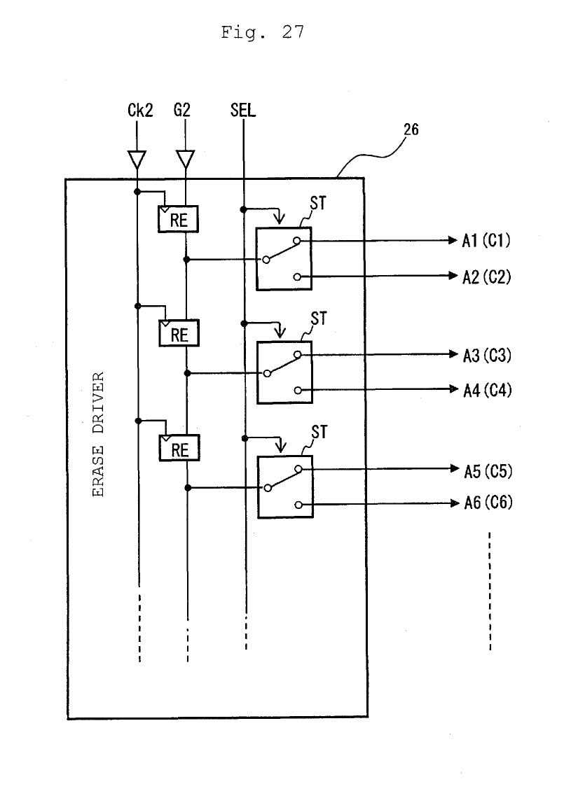

In the arrangement, when a control is performed to make emission patterns (emission periods) during a subframe period different in odd scan lines and in even scan lines, the control is performed as shown in a timing chart of FIG. 26. That is, after the completion of a write operation performed by the write driver 25 (E1 in the figure), the emission periods in the odd scan lines are controlled by writing erase data based on the erase control signal G2, and the emission periods (turned-on periods) in the even scan lines are controlled by writing the erase data based on the erase control signal G3 (E2 in the figure).

As described above, according to the fourth embodiment, clock signals in the write driver 25 and the erase driver 26 can be made to a common signal likewise the third embodiment described above, and further the same effect as that of the first embodiment can be obtained.

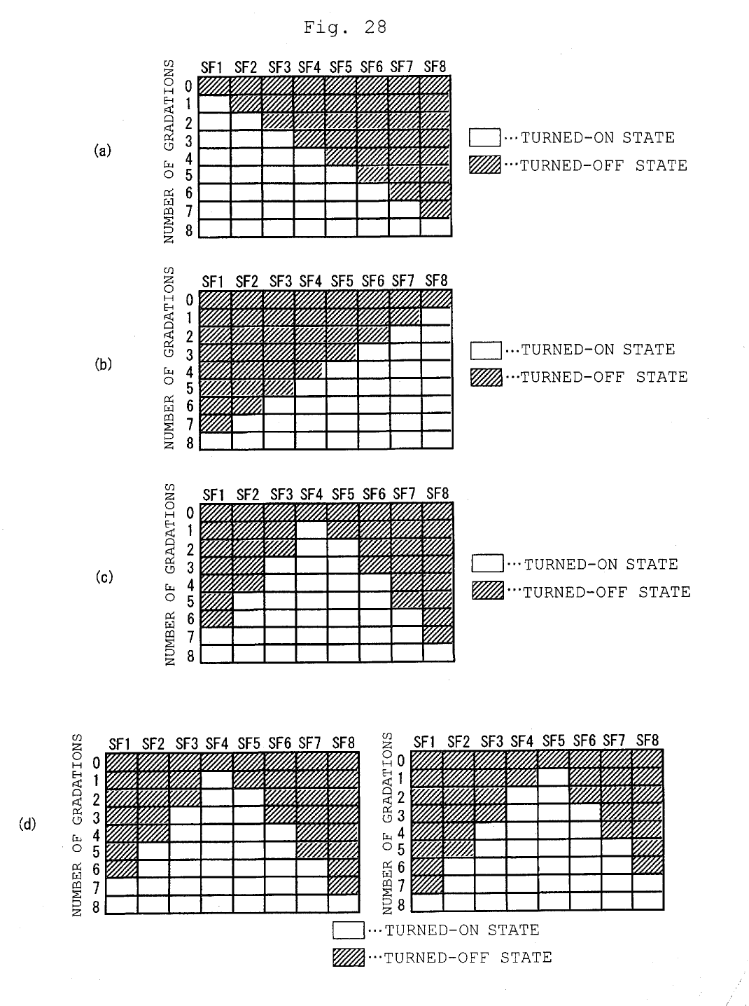

Subsequently, a fifth embodiment of the pixel driving apparatus and the pixel driving method according to the present invention will be explained. An arrangement in an erase driver 26 of the fifth embodiment is different from those of the first and second embodiments described above. FIG. 27 shows the arrangement of the erase driver 26 of the fifth embodiment.

As shown in the figure, selector circuits ST, which select any ones of odd scan lines and even scan lines as scan lines to which a control signal is supplied, are provided in the erase driver 26. A control signal G2 is input as input signal of the selector circuits ST as a signal for controlling an erase timing, an output control signal SEL is input to the selector circuits ST as a selection signal.

That is, with the arrangement, when a control is performed to make emission patterns (emission periods) during a subframe period different in odd scan lines and in even scan lines, a pixel turn-off operation is performed based on the erase control signal G2 after a scan line is selected based on the selection signal SEL after a write operation is performed by a write driver 25 during the subframe period.

As described above, according to the fifth embodiment of the present invention, the emission periods can be independently controlled in the odd scan line and in the even scan lines, and the same effect as that of the first embodiment can be obtained.

Note that, in the first to fifth embodiments, the emission pattern of the gradation expression by the simple subframe method can employ any of the plurality of emission patterns shown in, for example, FIG. 28(a) to (d). Note that FIG. 28 shows a case in which nine gradations are expressed by eight subframes (SF1 to SF8) as an example.

Further, these patterns may be switched to a different emission pattern in each frame or in each scan line (in particular, two emission patterns shown in FIG. 28(d) are switched in each frame, and the like). That is, expression noise can be reduced by the discontinuity of the emission patterns.

Further, although the embodiments describe above describe the control for switching the two emission patterns in each scan line (each of the even scan lines and the odd scan line), the control is not limited thereto. For example, the embodiments may perform a control for providing two or more emission patterns or a control for switching the emission patterns in each two or more scan lines in consideration of the facility of the occurrence and the circuit arrangement, and the like.

Although the embodiments described above show the arrangement in which the write drivers 25 and the erase drivers 26 are disposed on both the sides of the emission display panel 40, respectively in the figures, the arrangement of the pixel driving apparatus according to the present invention is not limited thereto and both the drivers may be disposed on one side of the display panel 40 together.

Further, in the embodiments described above, although the pixel data has 6 bits and the gradation expression is made by 64 for the purpose of convenience, the embodiments are not limited thereto, and the driving apparatus and the drive method according to the present invention can be also applied to more multi-gradation expression or in low gradation.

1. A pixel driving apparatus comprising a plurality of pixels disposed in the intersecting positions of a plurality of data lines and a plurality of scan lines and turned on by that pixel data signals are written thereto, wherein the plurality of pixels are divided to at least two scan groups depending on a period from writing of the pixel data signals to erasing thereof, the pixel driving apparatus characterized by comprising:
data line drive means for supplying the pixel data signals to the data lines;
scan line drive means for scanning the scan lines so that the pixel data signals supplied to the data lines by the data line drive means are written to the pixels; and
erase scan means for erasing the pixel data signals written to pixels by the scan line drive means in each of the scan groups
wherein the pixels of the scan groups are turned on so that they are made to a different emission pattern in each pattern respectively.

2. The pixel driving apparatus according to claim 1, characterized by comprising gradation expression means for time dividing one frame period to a plurality of subframe periods and performing gradation expression by the sum of the turned-on periods of one or a plurality of subframe periods, wherein the scan lines are scanned by the scan line drive means and the pixel data signals are erased by the erase scan means in the respective subframe periods time divided by the gradation expression means.

3. (canceled)

4. The pixel driving apparatus according to claim 1 or 2, characterized in that a write operation of the pixel data signals by the scan line drive means and an erase operation of the pixel data signals by the erase scan means are controlled such that they are performed during an overlapping period in one scan period.

5. The pixel driving apparatus according to claim 1 or 2 characterized in that a write operation of the pixel data signals by the scan line drive means and an erase operation of the pixel data signals by the erase scan means are controlled such that they are not overlapped with each other in one scan period.

6. A pixel driving method comprising a plurality of pixels disposed in the intersecting positions of a plurality of data lines and a plurality of scan lines and turned on by that pixel data signals are written thereto, wherein the plurality of pixels are divided to at least two scan groups depending on a period from writing of the pixel data signals to erasing thereof, the pixel driving method, characterized in that the pixel data signals are supplied to the data lines, the scan lines are scanned so that the pixel data signals, which are supplied to the data lines, are written to the pixels, and the pixel data signals written to the pixels are erased in each of the scan groups
wherein the pixels of the scan groups are turned on so that they are made to a different emission pattern in each pattern respectively.

7. The pixel driving method according to claim 6, characterized in that one frame period is time divided to a plurality of subframes, and gradation expression is performed by the sum of the turned-on periods of one or a plurality of subframe periods; and
scan of scan lines for writing the pixel data signals to the pixels and an erase operation of the pixel data signals written to the pixels are performed in the respective subframes period.

8. (canceled)

9. The pixel driving method according to claim 6 or 7, characterized in that a write operation of the pixel data signals and an erase operation of the pixel data signals are controlled such that they are performed in an overlapping period of one scan period.

10. The pixel driving method according to claim 6 or 7 characterized in that a write operation of the pixel data signals and an erase operation of the pixel data signals are controlled such that they are not overlapped in one scan period.
